(19) United States
(12) Patent Application Publication
(10) Pub. No.: US 2011/0141765 A1
(43) Pub. Date: Jun. 16, 2011

(54) PLANAR LIGHT SOURCE MODULE AND OPTICAL FILM

(75) Inventors: Yem-Yeu Chang, Chiayi County (TW); Chia-Jen Ting, Hsinchu County (TW)

(73) Assignee: INDUSTRIAL TECHNOLOGY RESEARCH INSTITUTE, Hsinchu (TW)

(21) Appl. No.: 12/958,403

(22) Filed: Dec. 2, 2010

(30) Foreign Application Priority Data
Dec. 15, 2009 (TW) 98142979

(51) Int. Cl. F21V 13/00; G02B 5/30

(52) U.S. Cl. 362/606; 359/489.09

(57) ABSTRACT

A planar light source module including a light guide plate (LGP), a light source, an optical film, and a reflector is provided. The light source for emitting a light beam is disposed adjacent to the side light-incident surface, wherein the light beam enters the LGP from a side light-incident surface and leaves the LGP from a light-emergence surface in an emergence angle θ1, θ1≧70 degrees. The optical film is disposed above the LGP to collimate the light beam from the LGP. The optical film includes a prism layer module and a bonding layer module stacked alternately. The prism layer module comprises prism layers and each prism layer includes micro-prisms. The bonding layer module comprises at least one bonding layer bonded with two prism layers adjacent thereto. The refraction index of the prism layers is greater than that of the bonding layer. The reflector is disposed under the bottom surface.

### CROSS-REFERENCE TO RELATED APPLICATION

This application claims the priority benefit of Taiwan application serial no. 98142979, filed on Dec. 15, 2009. The entirety of the above-mentioned patent application is hereby incorporated by reference herein and made a part of this specification.

### BACKGROUND OF THE INVENTION

1. Field of the Invention

The present application relates to a planar light source module. More particularly, the present application relates to a highly collimated planar light source module.

2. Description of Related Art

Presently, liquid crystal display (LCD) becomes one of the most popular industries, the LCDs are widely used in mobile phones, personal digital assistants (PDA), car monitors, screens of notebook computers, screens of desktop computers, and LCD-TVs, etc. Since a thin-film transistor LCD is a non-emission display, besides a LCD panel for displaying images is used, an additional backlight module is required for providing a planar light source. The commonly used backlight modules are approximately classified into direct type backlight modules and edge type backlight modules, wherein the edge type backlight modules are most popular.

FIG. 1 is a schematic diagram illustrating a conventional edge type backlight module. Referring to FIG. 1, the conventional edge type backlight module 100 includes a light guide plate (LGP) 110, a light source 120, a lower diffuser 130, a prism sheet 140, a prism sheet 150, an upper diffuser 160 and a reflector 170, wherein extending directions of micro-prisms on the prism sheet 140 are perpendicular to that of micro-prisms on the prism sheet 150. According to FIG. 1, it is known that besides the

LGP 110, the light source 120 and the reflector 170, four optical films (i.e. the lower diffuser 130, the prism sheet 140, the prism sheet 150 and the upper diffuser 160) are used, wherein a main function of the prism sheets 140 and 150 is to collimate a light beam to achieve a light gathering and a brightness enhancement effects, and the diffusers 130 and 160 have a function of diffusing and uniformizing the light beam, so as to reduce brightness (luminance) nonuniformity and shield an optical defect (such as a Moire pattern). In the conventional edge type backlight module 100, since a large number of the optical films are used, a fabrication cost and a thickness of the edge type backlight module 100 are not easy to be reduced.

However, since a light utilization rate of the LCD for the light provided by the backlight module is only 6%-10%, if the light utilization rate is increased, a power consumption of the LCD can be greatly reduced, and a service time of the electronic produce can be prolonged. To increase the light utilization rate of the LCD for the light provided by the backlight module, some documents (for example, a Japan Patent Publication No. JP 2006-337543 and a U.S. Pat. No. 7,164,454) provide several solutions.

The Japan Patent Publication No. JP 2006-337543 discloses a technique of using a micro-lens light gathering method to increase the light utilization rate of a transflective LCD panel for the light provided by the backlight source, and the U.S. Pat. No. 7,164,454 disclose a grating diffraction color splitting technique to replace conventional dye absorption color filters, so as to increase the light utilization rate. However, in these techniques, a highly collimated planar light source has to be used, so as to achieve an effective operation. Therefore, some research institutes provide a plurality of highly collimated backlight source techniques in succession, for example, U.S. Pat. Nos. 6,799,859, 6,473,220, 6,633,351 and 6,667,782. In the U.S. Pat. No. 6,799,859, a light refraction collimating film sheet is used to collimate an angle distribution of an emergence light of a LGP with a large angle refraction, though a collimation function thereof is limited. Moreover, in the U.S. Pat. No. 6,799,859, the full width at half maximum (FWHM) of a collimated light source is between 10-20 degrees. According to the U.S. Pat. No. 6,473,220, a mask having an opening is fabricated on the bottom of the LGP, so that the light beam is only transmitted along a light guided path within a high refractive index material, and the light direction is adjusted by total reflection, so as to achieve a purpose of light collimation. According to the U.S. Pat. No. 6,633,351, a mask having an opening is used to limit the light beam entering the device only through a focus of a lens, and then the lens is used to convert the light beam into an approximate parallel light beam. According to the U.S. Pat. No. 6,667,782, a difference of refractive indexes caused by multi-layer materials is used to control an angle of the light incident to a microstructure, so as to achieve a purpose of light collimation.

Although the aforementioned techniques can provide a highly collimated light source, they are not suitable for a mass production due to hard fabrication processes or complicated structures.

### SUMMARY OF THE INVENTION

The present application is directed to a planar light source module, and a planar light source provided by the planar light source module has a characteristic of high collimation.

The present application is directed to an optical film, which can effectively collimate light with a large incident angle, so as to provide a light beam with a highly collimated characteristic.

The present application provides a planar light source module including a light guide plate (LGP), a light source, an optical film, and a reflector. The LGP has a side light-incident surface, a bottom surface, and a light-emergence surface opposite to the bottom surface. The light source is disposed adjacent to the side light-incident surface, and is suitable for providing a light beam, wherein the light beam enters the LGP from the side light-incident surface and leaves the LGP from the light-emergence surface in an emergence angle θ1, wherein the emergence angle θ1≧70 degrees. The optical film is disposed above the light-emergence surface of the LGP to collimate the light beam from the LGP. The optical film includes a prism layer module and a bonding layer module. The prism layer module comprises a plurality of prism layers, and each of the prism layers includes a plurality of micro-prisms protruding towards a direction apart from the LGP, and extending directions of the micro-prisms are substantially perpendicular to a chief propagation direction of the light beam in the LGP. The bonding layer module comprises at least one bonding layer. The prism layers are alternately stacked with the bonding layers, and the bonding layer is bonded with two prism layers adjacent thereto. A refractive index of the prism layers is greater than that of the bonding layer. Moreover, the reflector is disposed under the bottom surface of the LGP.

The present application provides an optical film, which is suitable for collimating a light beam with an incident angle greater than 70 degrees. The optical film includes a prism layer module and a bonding layer module. The prism layer module comprises a plurality of prism layers, and each of the prism layers includes a plurality of micro-prisms. The bonding layer module comprises at least one bonding layer, wherein the prism layers are alternately stacked with the bonding layer, and the bonding layer is bonded with two prism layers adjacent thereto. A refractive index of the prism layers is greater than that of the bonding layer.

In order to make the aforementioned and other features and advantages of the present application comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional edge type backlight module.

FIG. 2 is a schematic diagram illustrating a planar light source module according to a first embodiment of the present application.

FIG. 3 is a schematic diagram illustrating a transmission path of a light beam in an optical film.

FIG. 4 is a diagram illustrating an optical simulation result of a planar light source module of FIG. 2.

FIGS. 5A-5D are cross-sectional views of different types of a micro-prism according to an embodiment of the present application.

FIG. 6 is a diagram illustrating a relationship between a light refraction angle and reflection light leakage when a light beam enters the air from a prism layer with a refractive index of 1.57.

FIGS. 7A and 7B are schematic diagrams illustrating a planar light source module according to a second embodiment of the present application.

FIGS. 8A-8E are schematic diagrams illustrating a fabrication process of an optical film according to an embodiment of the present application.

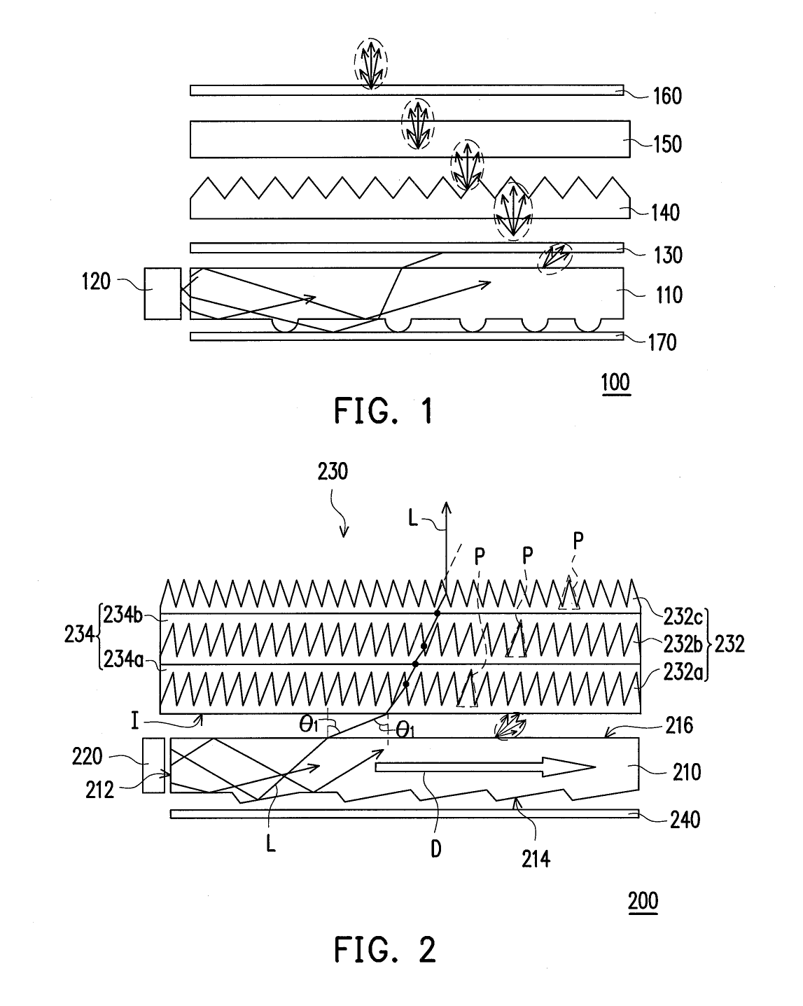

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a schematic diagram illustrating a planar light source module according to a first embodiment of the present application. Referring to FIG. 2, the planar light source module 200 of the present embodiment includes a light guide plate (LGP) 210, a light source 220, an optical film 230, and a reflector 240. The LGP 210 has a side light-incident surface 212, a bottom surface 214, and a light-emergence surface 216 opposite to the bottom surface 214. The LGP 210 of the present embodiment is, for example, a mirror dots LGP, a wedge-shaped LGP, a blasting spray LGP, or a LGP fabricated by a highly scattering optical transmission polymer (HSOT), etc.

The light source 220 is disposed adjacent to the side light-incident surface 212 of the LGP 210, and is suitable for providing a light beam L, wherein the light beam L enters the LGP 210 from the side light-incident surface 212 and leaves the LGP 210 from the light-emergence surface 216 in an emergence angle θ1, wherein the emergence angle θ1≧70 degrees. It should be noticed that the emergence angle θ1 refers to an emergence angle of the light beam L having a maximum light intensity. In the present embodiment, the light source 200 is, for example, a cold cathode fluorescent lamp (CCFL), a light-emitting diode (LED) light bar or other linear light sources. According to FIG. 2, it is known that after the light beam L provided by the light source 220 enters the LGP 210 from the side light-incident surface 212, since the bottom surface 214 is a surface having microstructures, the light beam L can be refracted by the microstructures of the bottom surface 214, so that a total reflection condition of the light beam L in the LGP 210 is spoiled, and then the light beam L is guided out. According to a suitable design of the bottom 214 (for example, an asymmetric micro-prism structure or an asymmetric micro-groove structure), the refracted and guided light beam L has a certain degree of directivity, and leaves the LGP 210 through the light-emergence surface 216. In another embodiment, the light-emergence surface 216 of the LGP 210 is a surface having the microstructures (not shown), which can guide the light beam L by spoiling the total reflection condition of the light beam L in the LGP 210. Namely, both of or one of the light-emergence surface 216 and the bottom surface 214 of the LGP 210 are/is surfaces/a surface having the microstructures, which are all used to spoil the total reflection condition of the light beam L in the LGP 210, so as to guide the light beam L out.

The optical film 230 is disposed above the light-emergence surface 216 of the LGP 210 to collimate the light beam L from the LGP 210. The optical film 230 includes a prism layer module 232 and a bonding layer module 234. The prism layer module 232 comprises a plurality of prism layers, and each of the prism layers includes a plurality of micro-prisms P protruding towards a direction apart from the LGP 210, and extending directions of the micro-prisms P are substantially perpendicular to a chief propagation direction D of the light beam L in the LGP 210. The prism layer and the bonding layers are alternately stacked. The bonding layer module 234 comprises at least one bonding layer, and the bonding layer is bonded with two prism layers adjacent thereto. Namely, a number of the bonding layers is determined according to a number of the prism layers. A refractive index of the prism layers is greater than that of the bonding layer. For example, a difference of the refractive indexes of the prism layers and the bonding layer is greater than or equal to 0.05.

For example, the prism layer module 232 comprises three prism layers 232a, 232b and 232c sequentially arranged a direction from an end close to the light-emergence surface 216 of the LGP 210 to an end far away from the same, and the bonding layer module 234 comprises two bonding layers 234a and 234b sequentially arranged in the same way. Wherein, the bonding layer 234a is bonded between the prism layer 232a and the prism layer 232b, and the bonding layer 234b is bonded between the prism layer 232b and the prism layer 232c. In overall, the bonded prism layers 232a, 232b and 232c and the bonding layers 234a and 234b can be regarded as the optical film 230 of multi-layer composite material optical films.

According to FIG. 2, it is known that a bottom surface (a surface close to the LGP 210) of each of the prism layers 232a, 232b and 232c is a plane, and a plurality of the micro-prisms P substantially parallel to each other is fabricated on a top surface (a surface apart from the LGP 210) of each of the prism layers 232a, 232b and 232c. Moreover, top surfaces (surfaces apart from the LGP 210) of the bonding layers 234a and 234b are planes, which are respectively attached to the bottom surfaces of the prism layers 232b and 232c, and bottom surfaces (surfaces close to the LGP 210) of the bonding layers 234a and 234b have shapes matched to the micro-prisms P of the prism layers 232a and 232b. It should be noticed that in an embodiment of the present application, the extending directions of the micro-prisms P of different prism layers 232a, 232b and 232c are substantially parallel. Here, the so-called “parallel” does not means that the extending directions of the micro-prisms P are limited to have no angle differences. Those with ordinary skill in the art can suitably adjust the extending directions of the micro-prisms P of the different prism layers 232a, 232b and 232c according to an actual demand. In an embodiment, a difference of the extending directions of the micro-prisms P of the different prism layers 232a, 232b and 232c is, for example, less than or equal to 4 degrees.

The optical film 230 has a light-incident surface I, wherein the light-incident surface I is substantially parallel to the light-emergence surface 216 of the LGP 210.

The reflector 240 is disposed under the bottom surface 214 of the LGP 210. In the present embodiment, the reflector 240 is a specular reflector with a high reflectivity, which is, for example, a silver reflector with a reflectivity more than 98%. In another embodiment of the present application, a 37W01 film fabricated by Reiko Company or an ESR film fabricated by 3M Company can be used to serve as the reflector 240.

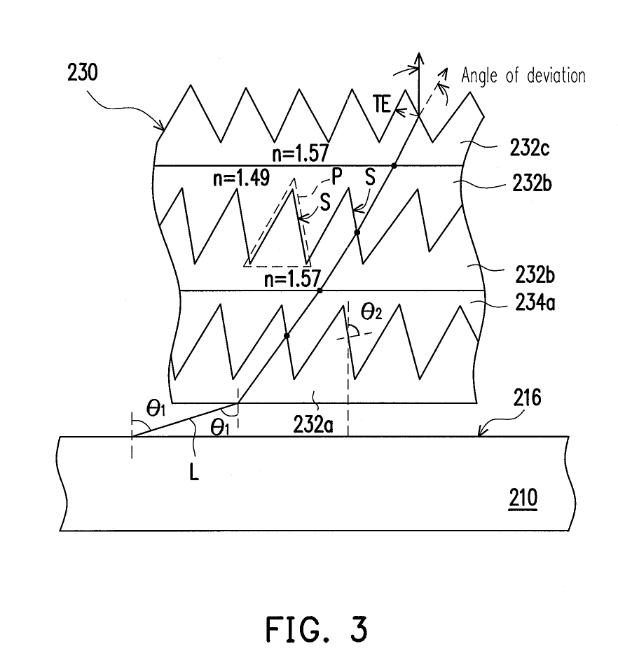

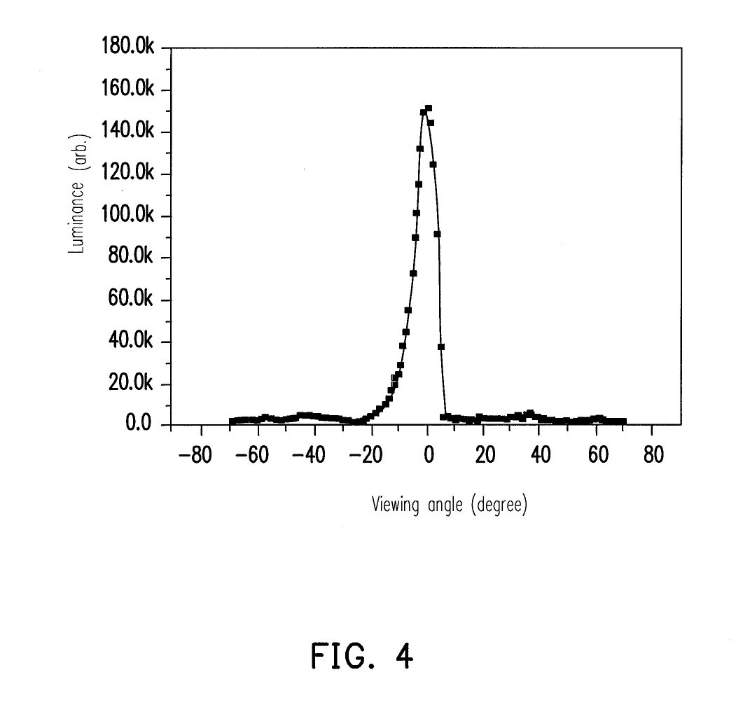

FIG. 3 is a schematic diagram illustrating a transmission path of the light beam L in the optical film 230. FIG. 4 is a diagram illustrating an optical simulation result of the planar light source module of FIG. 2. Referring to FIG. 3, in an embodiment of the present application, the prism layers 232a, 232b and 232c can be an ultraviolet (UV) plastic material with a refractive index of 1.57, the bonding layers 234a and 234b can be a UV plastic material with a refractive index of 1.49, and the emergence angle θ1 of the light-emergence surface 216 of the LGP 210 is 75 degrees. Under such conditions, after the light beam L passes through the prism layer 232a and the bonding layer 234a, a difference of the refractive indexes there between can result in a refraction angle of about 4-5 degrees. Similarly, after the light beam L continually passes through the prism layer 232b and the bonding layer 234b, a refraction angle of about 4-5 degrees is also generated. It should be noticed that after the light beam L is double refracted, and enters the air from the prism layer 232c, the light beam L can be collimated due to a further degree of refraction. According to FIG. 3, it is know that each of the micro-prisms P has an effective light refraction surface S, and an angle between a normal line of each of the effective light refraction surfaces S and a normal line of the light-emergence surface 216 is θ2, wherein 55 degrees≦θ2≦85 degrees.

Then, referring to FIG. 4, optical simulation software is used to analyse a Lambertian intensity distribution of the light source 220 according to a statistics approach, and after all of the light beams L pass through the optical film 230 of FIG. 3, a full width at half maximum (FWHM) of a luminance peak of about 8.8 degrees collimation is obtained.

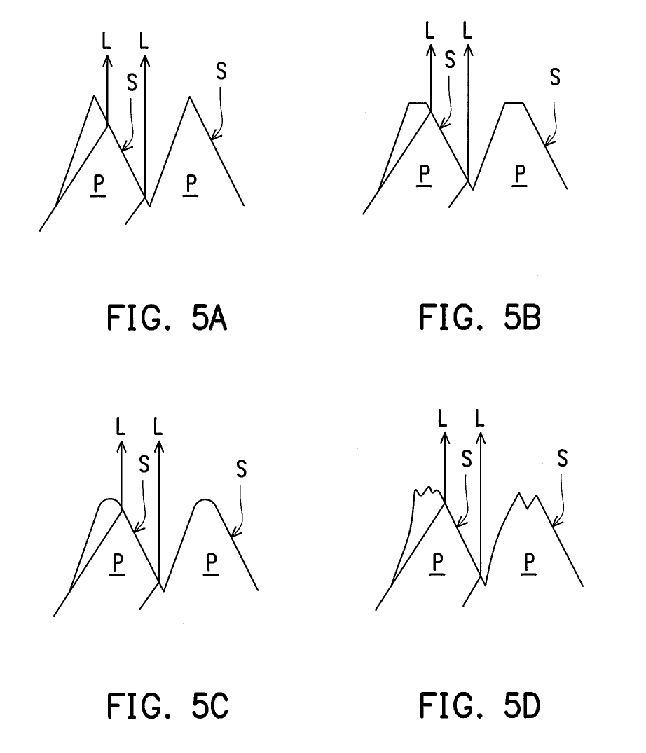

FIGS. 5A-5D are cross-sectional views of different types of the micro-prism P according to an embodiment of the present application. Referring to FIGS. 5A-5D, in the optical film 230 of the present embodiment, the micro-prism P is, for example, a micro-prism having a ridgeline (shown in FIG. 5A), a micro prism having a flat top (shown in FIG. 5B), a micro-prism having an arc top (shown in FIG. 5C), or a micro-prism having an irregular shape (shown in FIG. 5D). Here, the micro-prism having an irregular shape refers to that surfaces other than the effective light refraction surface S are irregular surfaces. It should be noticed that a vertex angle of the micro-prism P is, for example, between 30 degrees and 70 degrees, and each of the micro-prisms P is an asymmetric structure. In an embodiment of the present application, a feature size (height) of each of the micro-prisms P is, for example, between 10 μm and 100 μm. If the feature size (height) of the micro-prism P is excessive, a visual defect (such as mura phenomenon) is generated. Conversely, if the feature size (height) of the micro-prism P is too small, a diffraction effect is generated, and a whole luminance is reduced. Therefore, the feature size (height) of each of the micro-prisms P is between 10 μm and 100 μm.

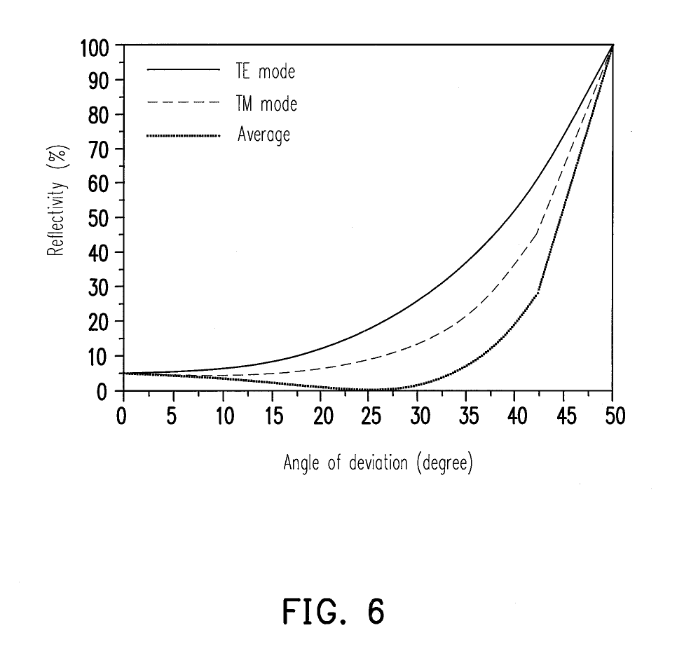

FIG. 6 is a diagram illustrating a relationship between a light refraction angle and reflection light leakage when the light beam enters the air from the prism layer 232c with the refractive index of 1.57. Referring to FIG. 3 and FIG. 6, since there is a great difference between the refractive indexes of the prism layer 232c of the optical film 230 and the air, when the light beam enters the air from the prism layer 232c with the refractive index of 1.57, 10%-20% of the light beam is probably reflected to form a stray light, which may influence a collimation of the light beam L. As shown in FIG. 6, when a TE mode polarized light and a TM mode polarized light enter the air from the prism layer 232c, the refractive indexes thereof are different. In detail, when the TE mode polarized light enters the air from the prism layer 232c, relatively more stray light is generated, and when the TM mode polarized light enter the air from the prism layer 232c, relatively less stray light is generated. Therefore, in the present embodiment, by disposing a polarizer, before the light beam L enters the optical film 230, it is first converted into the TM mode polarized light, so as to greatly reduce the stray light.

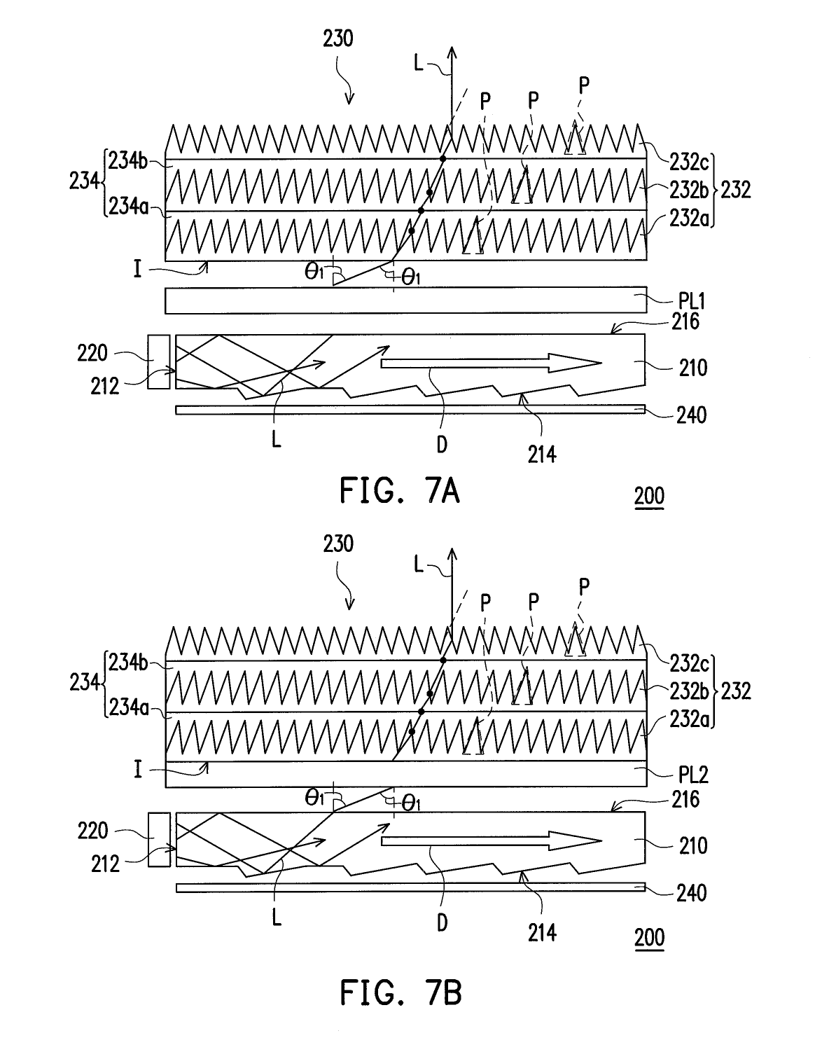

FIGS. 7A and 7B are schematic diagrams illustrating a planar light source module according to a second embodiment of the present application. Referring to FIG. 7A, to convert the light beam L into the TM mode polarized light before it enters the optical film 230, in the present embodiment, a polarizer PL1 can be disposed between the optical film 230 and the LGP 210. For example, the polarizer PL1 is, for example, a dual brightness enhancement film (DBEF) or a grating polarizer. Moreover, referring to FIG. 7B, the optical film 230 can also be directly fabricated on a polarizer PL2, and the prism layers 232a, 232b and 232c and the bonding layers 234a and 234b are alternately stacked on the polarizer PL2. Namely, the bottom surface (the surface close to the LGP 210) of the prism layer 232a is attached to the polarizer PL2, so as to integrate the optical film 230 and the polarizer PL2 into one optical device. Similarly, the polarizer PL2 is, for example, a DBEF or a grating polarizer.

According to the above descriptions, the optical film 230 in the planar light source module 200 can also be applied to the other optoelectronic devices (for example, an illumination device), so that application of the optical film 230 is not limited to the planar light source module.

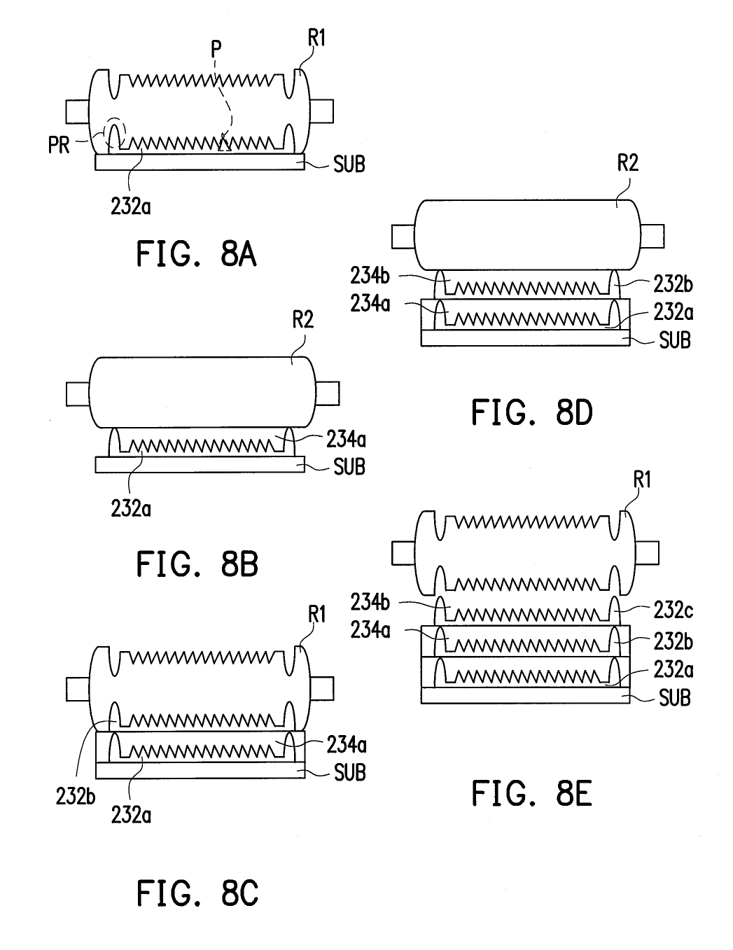

FIGS. 8A-8E are schematic diagrams illustrating a fabrication process of the optical film 230 according to an embodiment of the present application. Referring to FIG. 8A, a substrate SUB is first provided, and an optical material layer is formed on the substrate SUB. Then, a roller R1 with a surface having the microstructures is used to perform a press printing process to the optical material layer, so as to transfer the microstructures on the surface of the roller R1 to the optical material layer. Then, the optical material layer is cured to form the prism layer 232a having the micro-prisms P. In an embodiment of the present , application, the optical material layer used for fabricating the prism layer 232a can be a heat-curing material or an ultraviolet (UV)-curable material, and a method of curing the optical material layer includes heating or UV irradiating. It should be noticed that to avoid a crush and deformation of the micro-prisms P of the prism layer 232a during a post fabrication process, in the present embodiment, a prism protection protrusion PR is designed at periphery of the micro-prisms P, and a height of the prism protection protrusion PR is greater than a height of the micro-prisms P. The prism protection protrusion PR and the micro-prisms P can be together fabricated on the optical material layer through the roller R1.

Then, referring to FIG. 8B, an optical material layer is formed on the prism layer 232a through a roller R2, and then the optical material layer is cured to form the bonding layer 234a having a flat top surface. Similarly, the optical material layer used for fabricating the bonding layer 234a can be a heat-curing material or a UV-curable material, and a method of curing the optical material layer includes heating or UV irradiating.

Referring to FIGS. 8C-8E, the fabrication processes of FIG. 8A and FIG. 8B are repeated, so as to sequentially form the prism layer 232b, the bonding layer 234b and the prism layer 232c on the bonding layer 234a.

According to the above descriptions, since the optical film of the present application can effectively collimate the light with a large incident angle, a highly collimated light can be provided, so that the optical film can be applied to anti-peep displays and illumination devices.

It will be apparent to those skilled in the art that various modifications and variations can be made to the structure of the present application without departing from the scope or spirit of the invention. In view of the foregoing, it is intended that the present application cover modifications and variations of this invention provided they fall within the scope of the following claims and their equivalents.

What is claimed is:

1. A planar light source module, comprising:
a light guide plate (LGP) having a side light-incident surface, a bottom surface, and a light-emergence surface opposite to the bottom surface;
a light source disposed adjacent to the side light-incident surface and suitable for providing a light beam, wherein the light beam enters the LGP from the side light-incident surface and leaves the LGP from the light-emergence surface in an emergence angle θ1, wherein the emergence angle θ1≧70 degrees;
an optical film disposed above the light-emergence surface of the LGP to collimate the light beam from the LGP, and the optical film comprising:
a prism layer module comprising a plurality of prism layers, and each of the prism layers comprising a plurality of micro-prisms protruding towards a direction apart from the LGP, wherein extending directions of the micro-prisms are substantially perpendicular to a chief propagation direction of the light beam in the LGP;
a bonding layer module comprising at least one bonding layer, wherein the prism layers are alternately stacked with the at least one bonding layer, and the at least one bonding layer is bonded with two of the prism layers adjacent thereto, and a refractive index of the prism layers is greater than a refractive index of the at least one bonding layer; and
a reflector disposed under the bottom surface of the LGP.

2. The planar light source module as claimed in claim 1, wherein the optical film has a light-incident surface, and the light-incident surface is substantially parallel to the light-emergence surface of the LGP.

3. The planar light source module as claimed in claim 1, wherein both of or one of the light-emergence surface and the bottom surface of the LGP is a surface having microstructures.

4. The planar light source module as claimed in claim 1, wherein a difference between the refractive indexes of the prism layers and the at least one bonding layer is greater than or equal to 0.05.

5. The planar light source module as claimed in claim 1, wherein the extending directions of the micro-prisms in the prism layers are substantially parallel.

6. The planar light source module as claimed in claim 1, wherein a difference of the extending directions of the micro-prisms in the prism layers is less than or equal to 4 degrees.

7. The planar light source module as claimed in claim 1, wherein each of the micro-prisms has an effective light refraction surface, and an angle between a normal line of each of the effective light refraction surfaces and a normal line of the light-emergence surface is θ2, wherein 55 degrees≦θ2≦θ2≦85 degrees.

8. The planar light source module as claimed in claim 1, wherein each of the micro-prisms comprises a micro-prism having a ridgeline, a micro prism having a flat top, a micro-prism having an arc top, or a micro-prism having an irregular shape.

9. The planar light source module as claimed in claim 1, wherein a vertex angle of each of the micro-prisms is between 30 degrees and 70 degrees, and each of the micro-prisms is an asymmetric structure.

10. The planar light source module as claimed in claim 1, wherein a height of each of the micro-prisms is between 10 μm and 100 μm.

11. The planar light source module as claimed in claim 1, wherein each of the prism layers further comprises a prism protection protrusion, wherein the prism protection protrusion is located at periphery of the micro-prisms, and a height of the prism protection protrusion is greater than a height of the micro-prisms.

12. The planar light source module as claimed in claim 1, further comprising a polarizer disposed between the optical film and the LGP.

13. The planar light source module as claimed in claim 12, wherein the polarizer comprises a dual brightness enhancement film (DBEF) or a grating polarizer.

14. The planar light source module as claimed in claim 1, wherein the optical film further comprises a polarizer, wherein the prism layers and the at least one bonding layers are alternately stacked on the polarizer.

15. The planar light source module as claimed in claim 14, wherein the polarizer comprises a dual brightness enhancement film (DBEF) or a grating polarizer.

16. An optical film for collimating a light beam with an incident angle greater than 70 degrees, comprising:
a prism layer module comprising a plurality of prism layers, and each of the prism layers comprising a plurality of micro-prisms; and
a bonding layer module comprising at least one bonding layer, wherein the prism layers are alternately stacked with the at least one bonding layer, the at least one bonding layer is bonded with two of the prism layers adjacent thereto, and a refractive index of the prism layers is greater than a refractive index of the at least one bonding layer.

17. The optical film as claimed in claim 16, wherein a difference between the refractive indexes of the prism layers and the at least one bonding layer is greater than or equal to 0.05.

18. The optical film as claimed in claim 16, wherein extending directions of the micro-prisms in the prism layers are substantially parallel.

19. The optical film as claimed in claim 16, wherein a difference of extending directions of the micro-prisms in the prism layers is less than or equal to 4 degrees.

20. The optical film as claimed in claim 16, wherein each of the micro-prisms comprises a micro-prism having a ridgeline, a micro prism having a flat top, a micro-prism having an arc top, or a micro-prism having an irregular shape.

21. The optical film as claimed in claim 16, wherein a vertex angle of each of the micro-prisms is between 30 degrees and 70 degrees, and each of the micro-prisms is an asymmetric structure.

22. The optical film as claimed in claim 16, wherein a height of each of the micro-prisms is between 10 μm and 100 μm.

23. The optical film as claimed in claim 16, wherein each of the prism layers further comprises a prism protection protrusion, wherein the prism protection protrusion is located at periphery of the micro-prisms, and a height of the prism protection protrusion is greater than a height of the micro-prisms.

24. The optical film as claimed in claim 16, further comprising a polarizer, wherein the prism layers and the at least one bonding layers are alternately stacked on the polarizer.

25. The optical film as claimed in claim 24, wherein the polarizer comprises a dual brightness enhancement film (DBEF) or a grating polarizer.
